(19) United States
(12) Patent Application Publication
(10) Pub. No.: US 2011/0276952 A1
(43) Pub. Date: Nov. 10, 2011

(54) TELECOMMUNICATIONS APPLICATION GENERATOR

(75) Inventors: Artur TYLOCH, Warsaw (PL); Istvan NAGY, Budapest (HU); Dmytro ZAYATS, Arlington Heights, IL (US); Attila INCZE, Budapest (HU); Naheed VORA, Santa Clara, CA (US); Maarten ECTORS, Madrid (ES)

(73) Assignee: NOKIA SIEMENS NETWORKS OY, Espoo (FI)

(21) Appl. No.: 12/776,802

(22) Filed: May 10, 2010

(51) Int. Cl. G06F 9/45

(52) U.S. Cl. 717/140

(57) ABSTRACT

An arrangement for generating a telecommunications application (such as a voicemail application) is described. The arrangement provides a graphical user interface that enables a user to select telecommunications application building blocks and to position and connect those blocks on the display in order to define an algorithm. The algorithm can be implemented using pre-defined modules for said building blocks.

The present invention is directed to the generation of telecommunications applications.

Telecommunications applications, such as voicemail applications, are generally considered to be specialist applications that can only be generated by specialist computer programmers. Such applications require knowledge of the telecommunications elements involved in the particular application and require substantial computer programming skills.

Accordingly, to date, end users have not generally been able to build their own telecommunications applications. In particular, end users without advanced computer programming skills and detailed system knowledge have been prevented from developing their own applications.

The present invention seeks to address at least some of the problems outlined above.

The present invention provides a method (e.g. of generating a telecommunications application, such as a voicemail application) comprising: selecting a first telecommunications application building block and positioning said building block on a graphical display (i.e. a graphical user interface); repeating the selecting step with one or more additional instances of said first telecommunications application building block and/or with one or more instances of one or more other telecommunications application building blocks; and defining one or more connections between at least some of said telecommunications application building blocks in order to define a telecommunications application algorithm. The method may further comprise implementing said telecommunications application algorithm using pre-defined modules for said building blocks. The said pre-defined modules may comprise computer program code.

The present invention also provides a method comprising: receiving a telecommunications application algorithm comprising one or more instances of one or more telecommunications application building blocks (positioned on a graphical display) and further comprising definitions of (one or more) connections between at least some of said telecommunications application building blocks, wherein each of said telecommunication application building blocks has a pre-defined module implementing said building block associated therewith; and using said telecommunication application algorithm and said pre-defined modules to generate a telecommunications application. The said pre-defined modules may comprise computer program code.

The present invention further provides an apparatus (such as a telecommunications application generator) comprising: a first display module adapted to display a plurality of telecommunications application building blocks that are available to a user when generating a telecommunications application; a second display module adapted to display a telecommunications application generated by the user; a first mechanism enabling the user to select one or more of the telecommunications application building blocks that are available to the user and to position one or more instances of each of said one or more selected building blocks on the second display module; and a second mechanism enabling the user to define one or more connections between at least some of said selected telecommunications application building blocks in order to define a telecommunications application algorithm.

Accordingly, an arrangement is described for generating a telecommunications application (such as a voicemail application). The arrangement provides a graphical user interface that enables a user to select telecommunications application building blocks and to position and connect those blocks on the display in order to define an algorithm. The algorithm may be implemented using pre-defined modules for said building blocks.

Thus, the developer of the telecommunications application does not need to have programming skills, or understand the underlying technology of the telecommunications application he is developing. The code is typically pre-written: the user simply provides the positions of the coded elements on a visual display, and provides the connections between those coded elements. The pre-coded elements and the connections between them can be converted into a fully functioning telecommunications application on request.

The telecommunications application building blocks may be voicemail application building blocks.

The telecommunication application may be a voicemail application.

The apparatus of the invention may include a processor adapted to generate a telecommunication application on the basis of said defined telecommunication application algorithm using pre-defined modules for said building blocks.

The present invention further comprises a graphical user interface comprising: a first panel displaying a plurality of telecommunications application building blocks that are available to a user when generating a telecommunications application; and a second panel for displaying a telecommunications application algorithm generated by the user, wherein the telecommunications application algorithm is generated by the user by placing one or more instances of one or more selected telecommunications application building blocks displayed in the first panel in the second panel and by defining connections between said selected telecommunications application building blocks in said second panel. The graphical user interface may further comprise means for prompting a processor to convert the telecommunications application algorithm into a telecommunications application.

The present invention also comprises a computer program comprising: code (or some other means) for selecting a first telecommunications application building block and positioning said building block on a graphical display (i.e. a graphical user interface); code (or some other means) for repeating the selecting step with one or more additional instances of said first telecommunications application building block and/or with one or more instances of one or more other telecommunications application building blocks; code (or some other means) for defining one or more connections between at least some of said telecommunications application building blocks in order to define a telecommunications application algorithm. The computer program may further comprise code (or some other means) for implementing said telecommunications application algorithm using pre-defined modules for said building blocks. The computer program may be a computer program product comprising a computer-readable medium bearing computer program code embodied therein for use with a computer.

The present invention yet further provides a computer program product comprising: code (or some other means) for receiving a telecommunications application algorithm comprising one or more instances of one or more telecommunications application building blocks (positioned on a graphical display) and further comprising definitions of (one or more) connections between at least some of said telecommunications application building blocks, wherein each of said telecommunication application building blocks has a pre-defined module implementing said building block associated therewith; and code (or some other means) for using said telecommunication application algorithm and said pre-defined modules to generate a telecommunications application. The computer program may be a computer program product comprising a computer-readable medium bearing computer program code embodied therein for use with a computer.

Exemplary embodiments of the invention are described below, by way of example only, with reference to the following numbered schematic drawings.

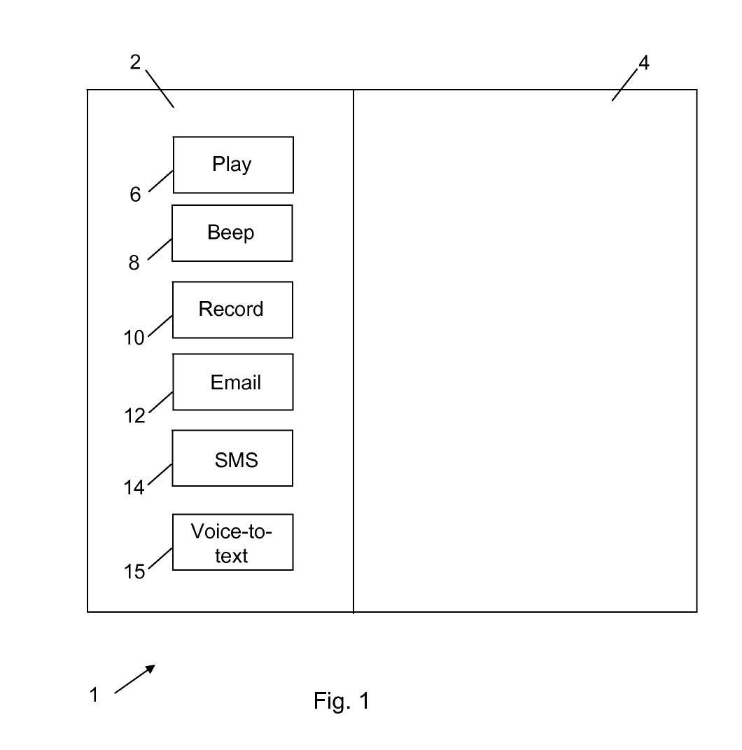

FIG. 1 shows an exemplary graphical user interface for a telecommunications application generator in accordance with an aspect of the present invention.

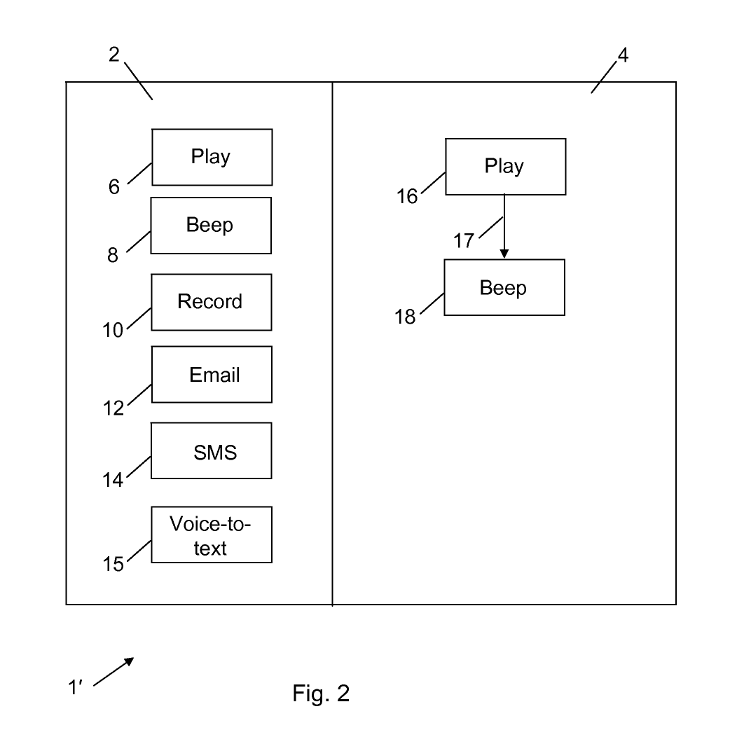

FIG. 2 shows the graphical user interface of FIG. 1 as used to generate a part of a telecommunications application, in accordance with an aspect of the present invention.

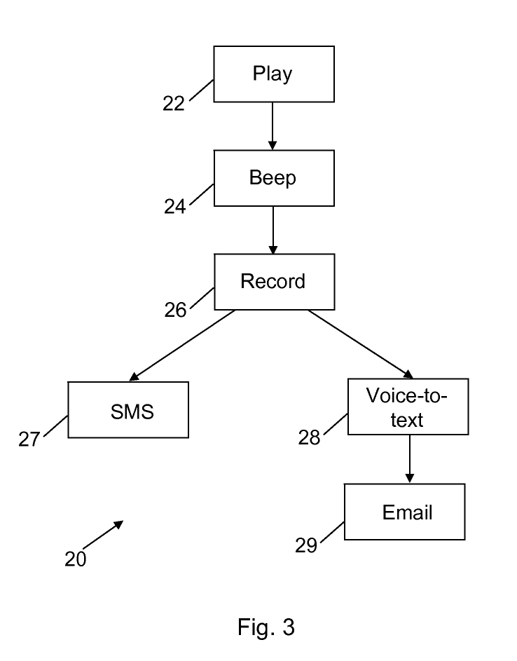

FIG. 3 is a flow chart of an exemplary application generated in accordance with an aspect of the present invention.

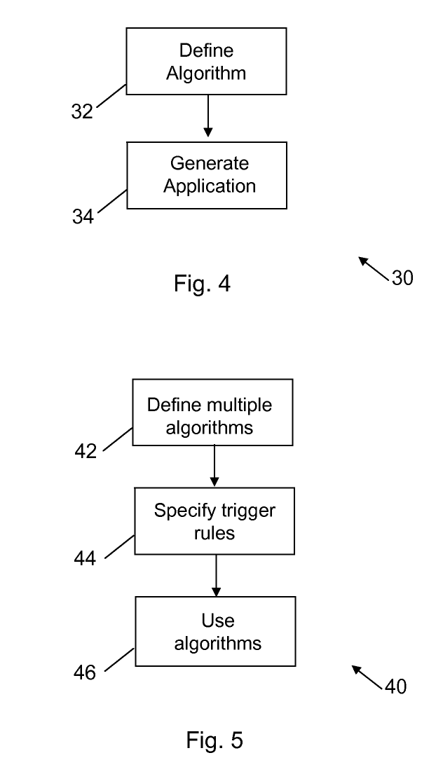

FIG. 4 is a flow chart showing an algorithm in accordance with an aspect of the present application.

FIG. 5 is a flow chart showing an algorithm in accordance with an aspect of the present application.

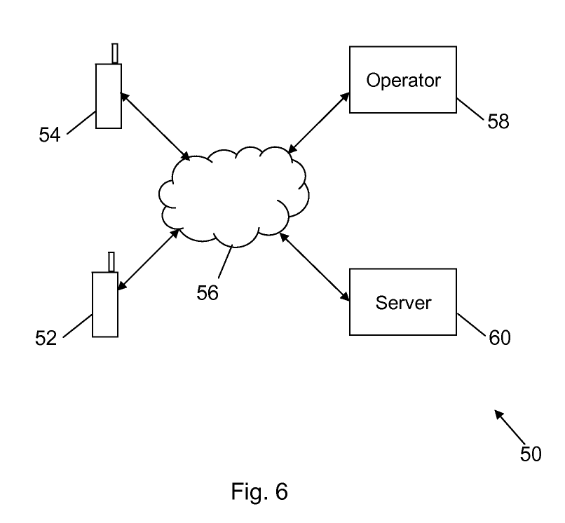

FIG. 6 is a block diagram of a system in which the present invention may be used.

FIG. 1 shows an exemplary graphical user interface for a telecommunications application generator, indicated generally by the reference numeral 1, in accordance with an aspect of the present invention.

The user interface 1 comprises a first panel 2 and a second panel 4. The first panel 2 includes a number of elements that can be used to define a telecommunications application. The second panel 4 is used to define and display a telecommunications application (as discussed further below).

The elements shown in the panel 2 of FIG. 1 are a play icon 6, a beep icon 8, a record icon 10, an Email icon 12, an SMS icon 14 and a voice-to-text icon 15.

The icons shown in the panel 2 are building blocks that can be used to build a telecommunications application. In order to define a telecommunications application, a user selects one of the icons and places an instance of that icon in the panel 4. The user places several icons (which may or may not include multiple instances of the same icon) in the panel and the joins the icons together (using an arrow) to generate an algorithm. Other building blocks (not shown in FIG. 1) could be provided, including an Instant Messaging building block or a text-to-voice building block. Building blocks may be provided to forward messages to a user's social network application. Building blocks could be provided that relate to non-voicemail related applications, such as a location-based-services module. The skilled person will be able to think of many more such building blocks that could be provided.

By way of example, FIG. 2 shows a graphical user interface indicated generally by the reference numeral 1′. The graphical user interface 1′ is the same as the graphical user interface 1, but additionally includes part of an exemplary telecommunications application shown in the second panel 4. Thus, the graphical user interface 1′ includes the icons 6, 8, 10, 12, 14 and 15 in the first panel 2. In addition, the graphical user interface 1′ includes an instance of the play icon 6 (shown as icon 16) and an instance of the beep icon 8 (shown as icon 18) in the second panel 4. The play icon 16 and beep icon 18 are joined by an arrow 17 that indicates that the algorithm shown starts at icon 16 and then moves to icon 18.

The icons 16 and 18 could be joined by drawing the arrow 17 in the user interface 1′. Alternatively, the icons 16 and 18 could be selected and a “connect” function invoked, perhaps by clicking on an icon on the user interface 1′ (not shown) or user a connect command shortcut.

FIG. 3 is a flow chart showing an application, indicated generally by the reference numeral 20, that can be generated using the graphical user interface 1 described above.

The application 20 starts at step 22, where a message is played. The message might ask the calling party to leave a message. The message played at the step 22 may be provided as an audio file. The algorithm 20 may provide a file location for the audio file and, in some forms of the invention, a called party (or a third party) may be able to change the file location of the audio file in order to change the message that is played. Alternatively, or in addition, the called party or a third party may be able to modify or replace the audio file itself.

Next, at step 24, a “beep” message is played. The beep may simply be an audible beep played to the calling party to indicate that a message should now be left. As with the step 22, the step 24 may include a reference to an audio file providing the beep message. As with the message played at step 22, the beep message could be modified, or the file location for the beep message could be modified.

The algorithm 20 then moves to step 26, which is a “record” step. At step 26, a message can be left by the calling party and that message is recorded.

Once the record step has been completed, the algorithm 20 divides in two, moving to both step 27 and 28.

At step 27 of the algorithm 20, an SMS message is sent to the called party informing them that a voicemail message has been left. The SMS message sent at step 27 might provide instructions of how the called party can retrieve the message. This branch of the algorithm 20 terminates once the step 27 has been completed.

At step 28 of the algorithm 20, a voice-to-text algorithm is applied to the message recorded at the record step 26 in order to transcribe any message left by the calling party. The algorithm 20 then moves to step 29, where the message transcribed at step 28 is placed into an email message, and that email message is sent to an email account of the called party. This branch of the algorithm 20 terminates once the step 29 has been completed.

The algorithm 20 is one of many voicemail algorithms that could be generated using the telecommunications application generator 1. Moreover, voicemail applications are one of many types of telecommunications application that can be generated by the telecommunications application generator 1. For example, a location based services module could be designed using the application generator 1. Indeed, any telecommunications application that consists of modules that can be applied and connected in an order using arrows can be defined using the telecommunications application generator 1.

As described above, the present invention enables a user to define a telecommunications application, such as a voicemail application, by positioning icons on a graphical display and defining connections between those icons. The present invention further includes the implementation of telecommunications application defined in this manner.

FIG. 4 is a flow chart showing an algorithm, indicated generally by the reference numeral 30, in accordance with an aspect of the present application. The algorithm 30 starts at step 32, where a telecommunication application algorithm is defined. The algorithm 30 then moves to step 34, where the defined algorithm is implemented.

In one form of the invention, each of the icons shown in the first panel 2 of the user interface has computer code associated with it. The computer code is a routine that can be called to implement the functionality of the icon. Accordingly, the step 34 of the algorithm can be implemented by calling the routine associated with the relevant icon when indicated by the application defined in the step 32.

FIG. 5 is a flow chart showing an algorithm, indicated generally by the reference numeral 40, in accordance with an aspect of the present application.

The algorithm 40 starts at step 42, where a user defines multiple applications. Each of the application may be defined using the algorithm 30 described above. For example, each application may be generated using the user interface 2 and the code behind each icon of the application (together with coding for the connections between the icons) may be used to generate a coding for each overall application. Each application can be saved as a file and can be called when necessary.

Next, at step 44, the user defines trigger rules for each of the applications generated at step 42. The trigger rules simply define when a particular application is called. Finally, the algorithms are used (step 46).

In this way, multiple applications can be generated, with each application being generated using simple icons. The multiple applications can then be combined in a more complex algorithm, by defining trigger rules.

Telecommunications application algorithms generated by the present invention may be bought and sold. Further, multiple applications, formulated using the algorithm 40, may be bought and sold. Moreover, multiple applications can be combined as defined in the algorithm 40, with some of those applications being defined using the algorithm 30, and some of those application being generated in other ways (e.g. by purchasing applications from a third party). Accordingly, the present invention provides a great deal of flexibility.

FIG. 6 is a block diagram of a telecommunications system, indicated generally by the reference numeral 50, in which the present invention may be used.

The system 50 comprises a communication device of a calling party 52, a communication device of a called party 54, a telecommunications network 56, a telecommunications operator 58 and a server 60 providing one or more voicemail applications. The calling party 52 uses the telecommunications network 56 to attempt to call the called party 54. One or more of the voicemail applications provided by the server 60 have been generated using the graphical user interface 1 described above.

The calling party 52 and/or the called party 54 may use a mobile communication device. The calling party 52 and/or the called party 54 may use a fixed-line communication device. The network 56 may be a mobile communications network or a fixed-line network. The operator 58 may be a mobile operator and/or a fixed-line operator.

In an exemplary use of the system, a telephone call may made (or attempted to be made) from the calling party 52 to the called party 54. Next, a determination is made (typically by a voicemail application provided by the server 60) that the call will not be accepted (or perhaps not even delivered) e.g. because the called party is unavailable (perhaps because the device is switched off) or because the called party refuses to accept the call. This step usually triggers the activation of a voicemail service of the operator 58. However, in the system 50, the voicemail application is used to replace (or work alongside) the normal voicemail service provided by the operator 58.

In one form of the invention, the called party needs to instruct the operator (in advance) to redirect voicemail serves to the server 60. Typically, the operator 58 implements voicemail services by diverting calls to its own voicemail service. This functionality can be used to arrange for the diversion to be made to the voicemail service provided by the server 60 rather that to the voicemail service provided by the operator 58.

The voicemail application 60 may, for example, implement the application 20 described above with reference to FIG. 3.

The embodiments of the invention described above have generally been directed to the generation and use of voicemail applications. However, the present invention is not limited to use with voicemail applications. For example, location-based services could be defined in a similar manner. Indeed, any telecommunications application consists of modules that can be pre-coded and linked in accordance with the principles of the present invention could be created using the telecommunications application generator of the present invention.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. A method comprising:
selecting a first telecommunications application building block and positioning said building block on a graphical display;
repeating the selecting step with one or more additional instances of said first telecommunications application building block and/or with one or more instances of one or more other telecommunications application building blocks; and
defining one or more connections between at least some of said selected telecommunications application building blocks in order to define a telecommunications application algorithm.

2. A method as claimed in claim 1, further comprising implementing said telecommunications application algorithm using pre-defined modules for said building blocks.

3. A method comprising:
receiving a telecommunications application algorithm comprising one or more instances of one or more telecommunications application building blocks and further comprising definitions of connections between at least some of said telecommunications application building blocks, wherein each of said telecommunication application building blocks has a pre-defined module implementing said building block associated therewith; and
using said telecommunication application algorithm and said pre-defined modules to generate a telecommunications application.

4. A method as claimed in claim 2, wherein said pre-defined modules comprise computer program code.

5. A method as claimed in claim 1, wherein said telecommunications application building blocks are voicemail application building blocks.

6. An apparatus comprising:
a first display module adapted to display a plurality of telecommunications application building blocks that are available to a user when generating a telecommunications application;
a second display module adapted to display a telecommunications application generated by the user;
a first mechanism enabling the user to select one or more telecommunications application building blocks that are available to the user and to position one or more instances of each of said one or more building blocks on the second display module; and
a second mechanism enabling the user to define one or more connections between at least some of said selected telecommunications application building blocks in order to define a telecommunications application algorithm.

7. An apparatus as claimed in claim 6, further comprising a processor adapted to generate a telecommunication application on the basis of said defined telecommunication application algorithm using pre-defined modules for said building blocks.

8. An apparatus as claimed in claim 7, wherein said pre-defined modules comprise computer program code.

9. An apparatus as claimed in claim 6, wherein said telecommunications application building blocks are voicemail application building blocks.

10. A graphical user interface comprising:
a first panel displaying a plurality of telecommunications application building blocks that are available to a user when generating a telecommunications application algorithm; and
a second panel for displaying a telecommunications application algorithm generated by the user,
wherein the telecommunications application algorithm is generated by the user by placing one or more instances of selected telecommunications application building blocks displayed in the first panel in the second panel and by defining connections between said selected telecommunications application building blocks in said second panel.

11. A graphical user interface as claimed in claim 10, further comprising means for prompting a processor to convert the telecommunications application algorithm into a telecommunications application.

12. A computer program product comprising:
means for selecting a first telecommunications application building block and positioning said building block on a graphical display;
means for repeating the selecting step with one or more additional instances of said first telecommunications application building block and/or with one or more instances of one or more other telecommunications application building blocks; and
means for defining one or more connections between at least some of said selected telecommunications application building blocks in order to define a telecommunications application algorithm.

13. A computer program product as claimed in claim 12, further comprising means for implementing said telecommunications application algorithm using pre-defined modules for said building blocks.

14. A computer program product comprising:
means for receiving a telecommunications application algorithm comprising one or more instances of one or more telecommunications application building blocks and further comprising definitions of connections between at least some of said telecommunications application building blocks, wherein each of said telecommunication application building blocks has a pre-defined module implementing said building block associated therewith; and
means for using said telecommunication application algorithm and said pre-defined modules to generate a telecommunications application.
